(19) United States
(12) Patent Application Publication
(10) Pub. No.: US 2021/0162290 A1
(43) Pub. Date: Jun. 3, 2021

(54) PORTABLE AND EXPANDABLE PRE-GAIT PARALLEL BARS

(71) Applicant: University of Utah Research Foundation, Salt Lake City, UT (US)

(72) Inventors: Doug Benson, Salt Lake City, UT (US); John Erdmann, Salt Lake City, UT (US)

(21) Appl. No.: 17/045,074

(22) PCT Filed: Apr. 10, 2019
(86) PCT No.: PCT/US19/26776

§ 371 Date: Oct. 2, 2020

Related U.S. Application Data
(60) Provisional application No. 62/655,620, filed on Apr. 10, 2018.

(51) Int. Cl. A63B 71/00; A63B 3/00; A61H 3/00

(52) U.S. Cl. CPC A63B 71/0036; A61H 3/00; A63B 3/00

(57) ABSTRACT

A portable rehabilitation assembly (100) for pre-gait rehabilitation comprises first and second lower support bars (102a, 102b) coupled together by an adjustable cross-member (104). A first pair of vertical frame members (108a) can be coupled to the first lower support bar (102a), and a second pair of vertical frame members (108b) can be coupled to the second lower support bar (102b). First and second hand rails (110a, 110b) can be coupled to respective vertical frame members (108a, 108b) to form an unobstructed walkway (W) from the front region (106a) to a back region (106b). First and second pairs of wheels (112a-d) can be coupled to respective lower support bars (102a, 102b). At least one actuation mechanism (114a, 114b) operates to move the assembly (100) from a stationary rehabilitation position to a portable position by causing the wheels (H2a-d) to lift the lower support bars (102a, 102b) from the ground surface for transport.

### RELATED APPLICATIONS

This application claims the benefit of U.S. Provisional Patent Application No. 62/655,620, filed Apr. 10, 2018, which is incorporated by reference herein.

### GOVERNMENT INTEREST

None.

### BACKGROUND

It is widely known that trauma patients can quickly lose muscle strength while in a hospital bed without periodic movement, such as daily walking. However, when patients are in an Intensive Care Unit, for example, they often have a variety of medical devices, monitor lines, ventilator hoses, IV lines, etc. attached to them (while in a large hospital bed). Such connections make it difficult or impossible to safely transport them to a rehabilitation center to begin pre-gait rehabilitation using standard pre-gait rehabilitation devices or equipment. Patients can also be quite disoriented and uncoordinated due to trauma, muscle atrophy, and/or medication while in intensive care. Thus, transporting such patients to another location for pre-gait rehabilitation can be complicated, time consuming, and dangerous.

### SUMMARY

However, it has been recognized that these patients should begin pre-gait rehabilitation as soon as possible; otherwise, they risk prolonged rehabilitation or other possible complications. Early pre-gait rehabilitation without removing such patients from their location can substantially reduce rehabilitation times and improve patient outcomes. Accordingly, a portable rehabilitation assembly for pre-gait rehabilitation of a patient can comprise first and second lower support bars positioned substantially parallel to each other, and a cross-member coupling the first and second lower support bars to each other proximate back ends of the first and second lower support bars. Front ends of the first and second lower support bars can form a front region. A first pair of vertical frame members can be coupled to the first lower support bar, and a second pair of vertical frame members can be coupled to the second lower support bar. A first hand rail can be coupled to the first pair of vertical frame members, and a second hand rail can be coupled to the second pair of vertical frame members and positioned substantially parallel to the first hand rail, such that the first and second hand rails and the front region form an unobstructed walkway from the front region to a back region of the portable rehabilitation assembly. A first pair of wheels coupled to the first lower support bar, and a second pair of wheels coupled to the second lower support bar, such that the first and second pairs of wheels are situated within a lateral distance defined by a width between the first and second lower support bars.

The present disclosure sets forth a portable rehabilitation assembly for pre-gait rehabilitation of a patient comprising first and second arced supports positioned substantially parallel to each other and configured to contact a ground surface. An adjustable cross-member can couple the first and second arced supports to each other proximate back ends of the first and second arced supports to adjust a width of the portable rehabilitation device. Front ends of the first and second arced supports can form a front region. A first pair of vertical frame members can be coupled to the first arced support, and a second pair of vertical frame members can be coupled to the second arced support and opposing the first pair of vertical frame members. A first hand rail can be coupled to the first pair of vertical frame members, and a second hand rail can be coupled to the second pair of vertical frame members and positioned substantially parallel to the first hand rail to form an unobstructed walkway from a back region proximate the back ends to the front region.

A method of using and/or transporting a portable rehabilitation assembly is provided, including operating an actuation mechanism to move the portable rehabilitation assembly between a stationary rehabilitation position and a portable rehabilitation assembly.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is an isometric view of a portable rehabilitation assembly in a first lateral position, in accordance with an example of the present disclosure.

FIG. 1B is an isometric view of the portable rehabilitation assembly of FIG. 1A in a second lateral position, in accordance with an example of the present disclosure.

FIG. 1C is a front view of the portable rehabilitation assembly of FIG. 1B in a second lateral position.

FIG. 1D is a left side view of the portable rehabilitation assembly of FIG. 1B.

FIG. 1E is an isometric view of a portion of an actuation mechanism of the portable rehabilitation assembly of FIG. 1A.

FIG. 1F is a side view of a cam of the actuation mechanism of FIG. 1E.

FIG. 1G is an isometric view of a portion of the actuation mechanism of the portable rehabilitation assembly of FIG. 1A.

FIG. 1H is a side view of a cam of the actuation mechanism of FIG. 1E.

FIG. 2A is an isometric view of a rehabilitation assembly portion usable with aspects of the portable rehabilitation assembly of FIG. 1A, in accordance with an example of the present disclosure.

FIG. 2B is an isometric view of the rehabilitation assembly portion of FIG. 2A.

FIG. 2C is an isometric view of a portion of the rehabilitation assembly portion of FIG. 2A.

FIG. 3A is an isometric view of a portion of a rehabilitation assembly portion useable with aspects of the portable rehabilitation assembly of FIG. 1A, in accordance with an example of the present disclosure.

FIG. 3B is an isometric view of the portion of the rehabilitation assembly portion of FIG. 3A.

FIG. 3C is an isometric view of a portion of the rehabilitation assembly portion of FIG. 3A.

FIG. 4A is an isometric view of a portion of an actuation mechanism that can replace the actuation mechanism of the portable rehabilitation assembly of FIG. 1A, in accordance with an example of the present disclosure.

FIG. 4B is an isometric view of a portion of the actuation mechanism of FIG. 4A.

FIG. 5A is an isometric view of a rehabilitation assembly portion usable with aspects of the portable rehabilitation assembly of FIG. 1A, in accordance with an example of the present disclosure.

FIG. 5B is an isometric view of a portion of the rehabilitation assembly portion of FIG. 5A.

FIG. 5C is a cross sectional view of the rehabilitation assembly portion of FIG. 5A.

FIG. 5D is a front view of the rehabilitation assembly portion of FIG. 5A.

FIG. 6 is an isometric view of a portable rehabilitation assembly, in accordance with an example of the present disclosure.

FIG. 7 is an isometric view of a portable rehabilitation assembly, in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a vertical frame member” includes reference to one or more of such features and reference to “extending” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Portable Pre-Gait Rehabilitation Device

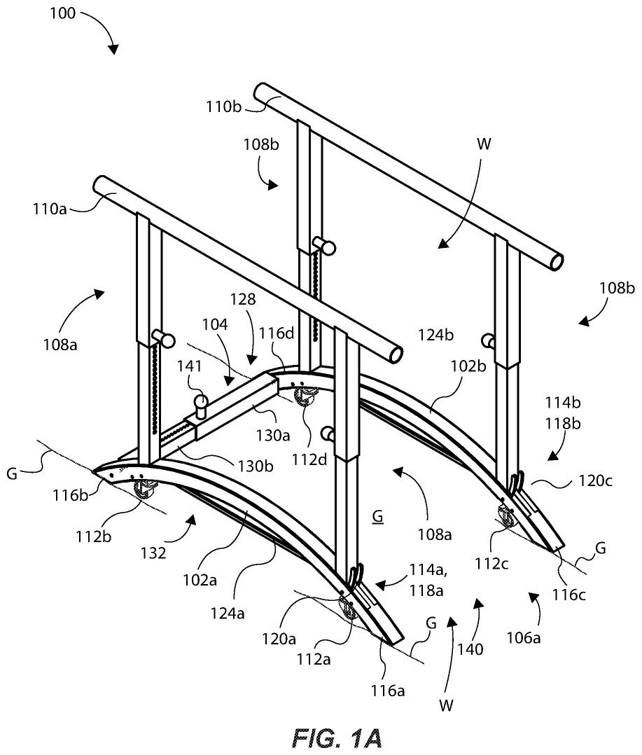

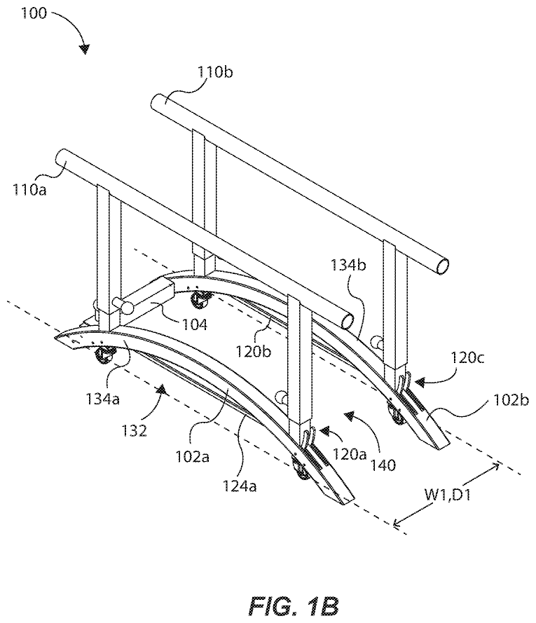

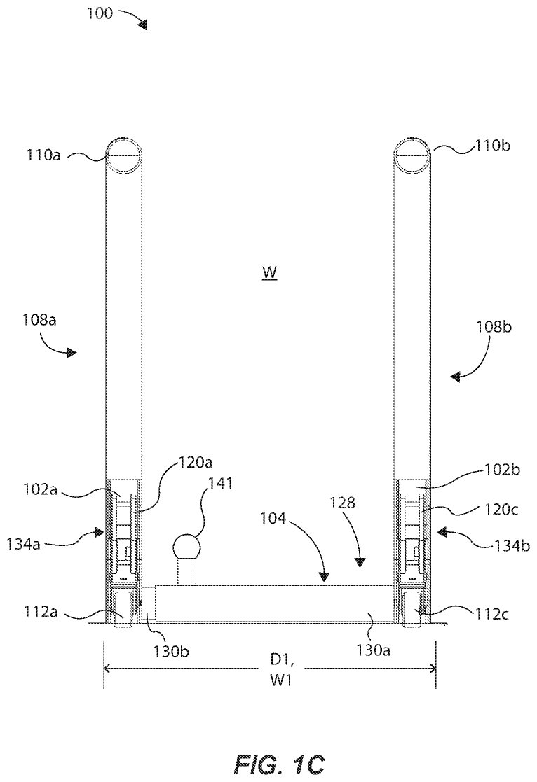

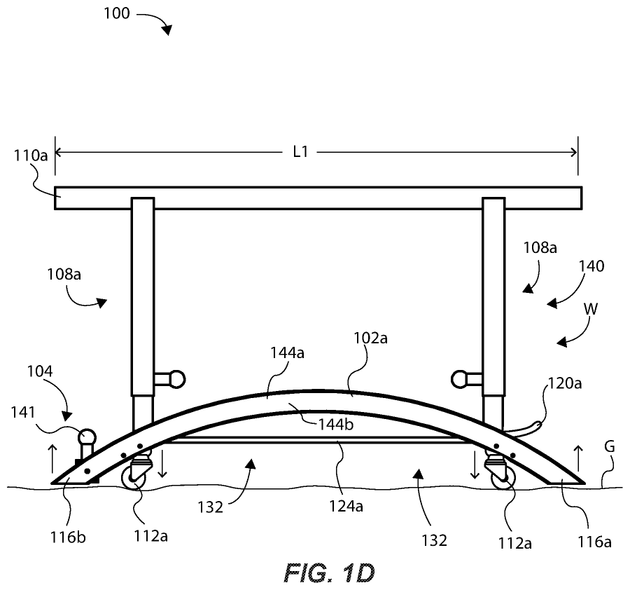

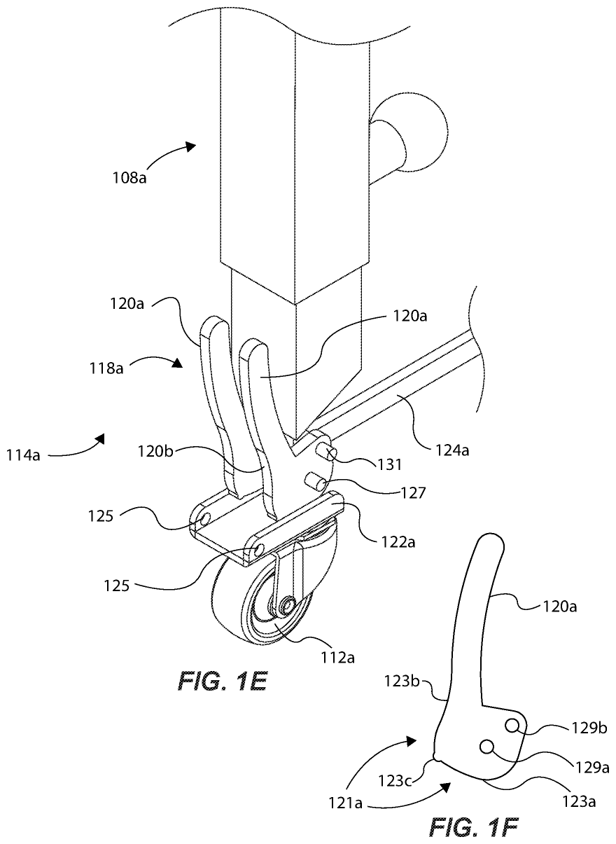

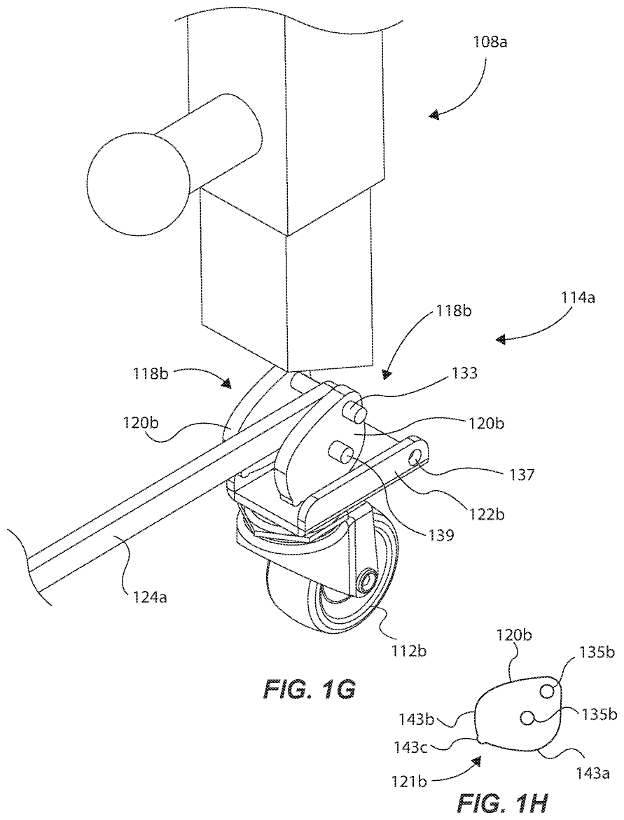

FIGS. 1A-1H illustrate various aspects and components of a portable rehabilitation assembly 100, in accordance with one example of the present disclosure. The portable rehabilitation assembly 100 can comprise first and second lower support bars 102a and 102b positioned substantially parallel to each other along their lengths, and a cross-member 104 coupling together the first and second lower support bars 102a and 102b proximate their back ends. Front ends of the first and second lower support bars 102a and 102b can form a front region 106a, and back ends of the first and second lower support bars 102a and 102b can form a back region 106b opposite the front region 106a along the length of the assembly 100. A first pair of vertical frame members 108a can be coupled to the first lower support bar 102a, and a second pair of vertical frame members 108b can be coupled to the second lower support bar 102b and opposing the first pair of vertical frame members 108a in a lateral direction. A first hand rail 110a can be coupled to the first pair of vertical frame members 108a, and a second hand rail 110b can be coupled to the second pair of vertical frame members 108b and positioned substantially parallel to the first hand rail 110a. Typically, the first and second hand rails 110a and 110b can be horizontally oriented parallel to the lower support bars 102a and 102b, and perpendicular to the vertical frame members 108a and 108b. Thus, the first and second handrails 110a and 110b, and the lower support bars 102a and 102b, can form or define an unobstructed walkway W from the front region 106a to the back region 106b.

Accordingly, a user or patient can walk along a ground surface G through the front region 106a while holding the handrails 110a and 110b, such that the patient's movement or gait is unobstructed by the portable rehabilitation assembly 100 from the front region 106a to proximate the back region 106b. Said another way, the portable rehabilitation assembly 100 does not have a platform or other structure covering the ground surface G along the walkway W1, which could be considered an “obstructed walkway” because the patient would need to walk onto or step over such platform to use the assembly. This can be a safety hazard. Accordingly, using the assembly 100 (and the other assemblies disclosed herein), the patient can merely use the existing ground surface G as a walkway, because the ground surface G directly supports the assembly 100. Moreover, not having a platform can dramatically reduce the weight of a particular portable rehabilitation assembly, which contributes to the portability of the assembly 100, for instance.

In one example, a pairs or a plurality of wheels 112a-d can be movably supported by respective first and second lower bars 102a and 102b for facilitating transportation of the portable rehabilitation assembly 100, such as between usage by patients. In one example, the wheels 112a-d can be retractable wheels oriented on an underside of the first and second lower bars 102a and 102b. Thus, the wheels 112a-d can be configured to allow the portable rehabilitation assembly 100 to be movable when the wheels 112a-d are extended from the support bars 102a and 102b for transport.

Typically, the wheels 112a-d can be “in-line” with the respective first and second lower support bars 102a and 102b. For example, a first pair of wheels 112a and 112b can be coupled to the first lower support bar 102a, and a second pair of wheels 112c and 112d can be coupled to the second lower support bar 102b. The first and second pairs of wheels 112a-d can each be situated within a lateral support distance D1 defined by a width W1 (FIGS. 1B and 1C) defined by the respective first and second lower support bars 102a and 102b (i.e., the lateral support distance D1 can be defined by outer side surfaces of the first and second lower support bars 102a and 102b). Thus, the wheels 112a-d are each in-line within the width of the respective support bars 102a and 102b, so that no portion (or very little portion) of the wheels 112a-d extend outwardly or inwardly from the support bars 102a and 102b, which can obstruct the walkway W and cause safety concerns of patients tripping over the wheels when using the assembly 100.

The portable rehabilitation assembly 100 can comprise first and second actuation mechanisms 114a and 114b operably coupled to respective first and second pairs of wheels 112a-d, and supported by respective first and second lower support bars 102a and 102b. The first and second actuation mechanisms 114a and 114b can be operable by a user to move the portable rehabilitation assembly 100 from a stationary rehabilitation position (FIG. 1A) to a portable position (FIG. 1D) by engaging and operating the first and second actuation mechanisms 114a and 114b to move the first and second pairs of wheels 112a-d to extended positions to interface with the ground surface G. Such operation thereby lifts ground contact points 116a-d of the first and second lower support bars 102a and 102b away from the ground surface G, so that only the wheels 112a-d are touching the ground surface G for transporting the portable rehabilitation assembly 100 in the portable position, as illustrated in FIG. 1D. Note that the wheels 112a-d may be slightly contacting the ground surface G when the portable rehabilitation assembly 100 is in the stationary rehabilitation position, but the majority of the support would be provided by the first and second lower support bars 102a and 102b contacting the ground.

The terms or phrase “stationary rehabilitation position” refer to the position shown in FIG. 1A in which the ground surface G supports the first and second lower support bars 102a and 102b so that the assembly 100 is ready for pre-gait rehabilitation by a patient. Conversely, the phrase “portable position” can mean the position shown in FIG. 1D, for instance, in which the first and second lower support bars 102a and 102b are lifted or raised upwardly away from the ground surface G, so that only the wheels 112a-d are interfaced to the ground surface G for wheeled movement of the assembly 100 by a clinician for transporting the assembly 100.

FIGS. 1E-1H show various aspects of the first and second actuation mechanisms 114a and 114b, which can be similarly constructed as each other, and can be arranged with the lower support bars 102a and 102b for lifting them from the ground surface G (and for lowering the lower support bars 102a and 102b to the ground surface G for use). More specifically, the first actuation mechanism 114a (for use with lower support bar 102a) can comprise first and second cam mechanisms 118a and 118b (FIGS. 1E and 1G) that are situated at opposing ends of the first lower support bar 102a. Note that FIGS. 1E and 1G do not show the ends of the first lower support bar 102a for purposes of illustration clarity. However, it should be appreciated from the below discussion and the drawings that the lower support bar 102a supports the pair of vertical frames 108a and various aspects of the cam mechanisms 118a and 118b.

In some examples, the at least one actuation mechanism comprises a first cam device operably coupled to the first pair of wheels and supported by the first lower support bar, and a second cam device operably coupled to the second pair of wheels and supported by the second lower support bar. Thus, the first cam mechanism 118 can comprise a first pair of foot levers 120a (i.e., cam bodies or devices), which can each comprise a lobed or cam profile 121a that extends about sides of the foot lever 120a, as illustrated in FIG. 1F. The cam profile 121a can be defined by a first cam surface 123a that extends generally horizontally, and a second cam surface 123b that extends generally vertically from the second cam surface 123a. A stop portion 123c extends between the first and second cam surfaces 123a and 123b, which can be a rounded or curved protrusion proximate the turn or corner of the cam profile 121a.

The foot levers 120a can be vertically supported by, and movable relative to, a bracket 122a coupled to the wheel 112a. The bracket 122a can have side apertures 125 that receive respective pins (not shown) that extend through side apertures of the lower support bar 102a (see FIGS. 1A and 1B). In this configuration, the lower support bar 102a can pivot about these pins relative to the bracket 122a when moved between the stationary and portable positions. Each foot lever 120a can be pinned to the lower support bar 102a via pins 127 (one shown) that extend through side apertures 129a of the foot levers 120a and through respective side apertures of the lower support bar 102a. In this configuration, the lower support bar 102a can pivot about the pins 127 relative to the foot levers 120a when moved between the stationary and portable positions.

The first actuation mechanism 114a can further comprise an actuation rod 124a coupling together the first and second cam mechanisms 118a and 118b. Thus, one end of the rod 124a can be pivotally pinned through rod apertures 129b of both foot levers 120a via a pin 131. In this configuration, the foot levers 120a can pivot about the rod 124a when moved between the stationary and portable positions. Accordingly, when a user pushes downwardly on the foot levers 120a (when the assembly 100 is in the stationary position), the foot levers 120a roll about a planar surface of the bracket 122a, such that the first cam surface 123a rolls and extends upwardly while the third cam surface 123c also rolls along the bracket 122a. Then, the second cam surface 123b is laid generally horizontally along the planar surface of the bracket 122a. This movement causes an upward force to the front end of the first lower support bar 102a via loads transferred through the pins between the bracket 122a and the support bar 102a, then transferred through the pins 127 between the foot levers 120a and the support bar 120a. Thus, rotational movement of the foot levers 120a causes linear movement of the lower support bar 102a relative to the wheel 112a, which lifts the support bar 102a off the ground. This is, in part, because of the geometry of the foot levers 102a, whereby the height of the foot levers 120a is increased when actuated and moved to the portable position. Note that the foot levers 120a can be moveable through top slots formed through upper surfaces of the first and second lower support bars 102a and 102b, as shown in FIG. 1A.

Concurrently while the foot levers 120a are actuated and rotated downwardly, the second cam mechanism 118b is actuated via the actuation rod 124a. More specifically, as shown in FIG. 1G, the second cam mechanism 118a can comprise a pair of cam devices 120b that are similarly formed and arranged parallel to each other for facilitating movement of the wheel 112b relative to the lower support bar 102a. The end of the actuation rod 124a can be situated laterally between the cam devices 120b (similarly as the foot levers 120a), and can be pinned to both cam devices 120a via a pin 133 that extends through an aperture of the actuation rod 124a and through respective apertures 135a of the cam devices 120b. A bracket 122b, coupled to the wheel 112b, can be pinned to the back end of the lower support bar 102b via side apertures 137 and pins (not shown, but see FIGS. 1A and 1B for reference). The cam devices 120b can also be pinned to the lower support bar 102a via respective side pins 139 (one shown) that extend through respective side apertures of the lower support bar 102a and through apertures 135b of each cam device 120b.

With respect to FIG. 1H, the cam devices 120b can each comprise a cam profile 121b including first and second cam surfaces 143a and 143b, and a stop portion 143c (similarly shaped as cam profile 121a of the foot lever 120a of FIG. 1F). Thus, when a pulling force is applied to the actuation rod 124a via operation of the foot levers 120a (discussed above), the cam devices 120b are pulled toward the left and rotated counterclockwise, such that the cam profile 121b rolls along a planar surface of the bracket 122b until the cam surface 143b is interfaced to the bracket 122b. Because of the profile of the cam device 120b, this rotation of the cam device 120b causes a linear lifting force against the end of the lower support bar 102a relative to the wheel 112b. Once the foot levers 120a and the cam devices 120b have been rotated and actuated, their stop portions 123c and 143c are biased against the respective brackets 122a and 122b to act as stops which holds the assembly 100 in the portable position by supporting the weight of the lower support bars 102a and 102b (and the components supported thereon). Note that the actuation mechanism 114b on the other side of the assembly 100 operates in the same manner. Thus, the assembly 100 can be moved back to the stationary position by rotating the foot levers 120a and 120c, which lowers the support bars 102a and 102b to interface with the ground surface, thereby reducing or eliminating a load between all the wheels 112a-d and the ground surface G. Alternatively, the assembly 100 can be automatically moved back to the stationary position by applying sufficient force (e.g., 60 pounds or more) downwardly onto the handrails 110a and 110b to overcome the friction force or load at the stop portions 123c and 143c, so that the foot levers 120a and the cam devices 120b automatically rotate back to the positions shown in FIGS. 1E and 1G, thereby moving the assembly 100 back to the stationary position for use.

With reference back to FIGS. 1A-1C, the cross member 104 can comprise a lateral adjustment mechanism 128 that is operable to adjust (e.g., expand) a distance between the first and second lower support bars 102a and 102b, thereby adjusting a distance between the first and second hand rails 110a and 110b and adjusting a width of the walkway W. The lateral adjustment mechanism 128 can comprise first and second telescopic support members or tubes 130a and 130b operate to telescope with each other to adjust a distance between the first and second lower support bars, and a distance between the first and second hand rails. The first tube 130a can be a square tube (or other shape) that slidably receives the second tube 130b bi-directionally. The second tube 130b can have upper holes for receiving a pin lock device 141 operable by a user to lock the first and second tubes 130a and 130b to each other by engaging a pin into one of the upper holes. Therefore, in this example the width between the hand rails 110a and 110b is only adjusted by operation of the lateral adjustment mechanism 128, which also defines the width between the first and second lower support bars 102a and 102b to accommodate for different sizes of patients and different gaits. This functionality is illustrated by comparing the wide or expanded position of FIG. 1A as compared to the narrow or collapsed position of FIG. 1B. Note that the cross member 104 may alternatively comprise a single cross bar that is fixedly attached to the first and second lower support bars 102a and 102b, so that the width of the assembly 100 is not adjustable.

Note that many existing hand rails are adjusted locally at the hand rail (i.e., not being adjustable by adjusting the width between lower support bars), which is disadvantageous because the entire lower profile or width of such prior systems remains the same (e.g., wide) while only the hand rails are adjusted laterally to be more narrow, for instance. Such traditional rehabilitation assembly can consume excessive floor space because the width of the base area remains the same regardless of the distance between the handrails, which can limit the areas that such traditional rehabilitation assembly can be transported around a facility and used by a patient. However, the portable rehabilitation assembly 100 of the present disclosure provides a configuration where the width of the assembly 100 can be adjusted by only operating the lateral adjustment mechanism 128, which minimizes the floor space used by the assembly 100, and maximizes the areas/easements that the assembly 100 can be transported through in a hospital or clinic environment without having to disassemble or reorient the assembly just to enter through a narrow doorway, for instance.

In some examples, first and second cross bars or tubes can each be hinged or pivotally coupled to respective first and second lower support bars (e.g., 102a and 102b), and operated to be removably coupled to each other when in the stationary position. Thus, when such pivotable first and second cross bars or tubes are uncoupled from each other, they can each be pivoted inwardly toward respective first and second lower support bars 102a and 102b for a compact storage and transportation. In another example, hinges can be used to pivotally couple such the first and second tubes in an alternating manner so that the portable rehabilitation assembly 100 is collapsible on itself while the first and second telescopic support members remain engaged to each other (i.e., in a Z-shaped collapsible manner).

The first and second lower support bars 102a and 102b can comprise an arced or concave profile that extends from the back region to the front region of the portable rehabilitation assembly 100. More specifically, each support bar 102a can comprise an upper convex portion 144a (FIG. 1D) that supports respective first and second pairs of vertical frames 108a and 10b, and a lower concave portion 144b that supports respective first and second pairs of wheels. The arced profile of each lower support bar 102a and 102b can define a void 132 underneath the lower concave portion 144b, such that the respective wheels 112a-d can be at least be partially (or wholly) situated within the void 132 of each lower support bar 102a and 102b. Positioning the wheels 112a-d in this manner prevents the wheels 112a-d from extending outwardly beyond outer surfaces 134a and 134b of the respective first and second lower support bars 102a and 102b (see FIG. 1C). These outer surfaces 134a and 134b can define an overall or general lateral profile of the portable rehabilitation assembly 100, because no other feature or portion extends outwardly beyond the outer surfaces 134a and 134b. Thus, outer surfaces of each of the first and second lower support bars can define an overall lateral profile of the portable rehabilitation assembly, and the first and second pairs of wheels can be situated within the overall lateral profile.

The arced profiles of the first and second lower support bars 102a and 102b can define a lower perimeter boundary (e.g., a rectangular plane parallel to the ground) of the portable rehabilitation assembly 100. Because of the aforementioned features, the portable rehabilitation assembly 100 is relatively narrow and streamlined along the lower sides of the assembly 100, which helps to reduce the likelihood of individuals tripping on the wheels or other features that may typically extend outwardly along the floor area, as with prior assemblies. This streamlined side-to-side profile further prevents damage to walls and doorjambs when the rehabilitation assembly 100 is transported through hallways and doorways. Note that, because the wheels 112a-d may be omni-directional casters, when in use, a portion of the wheel(s) may pivot outwardly beyond the lower support bars, such as when turning the device around corners. Further, in some cases, the first and second wheels do not extend outwardly beyond the lower perimeter boundary defined by the first and second lower support bars.

The portable rehabilitation assembly 100 can comprises or define the unobstructed walkway W (e.g., a generally rectangular cuboid region) between the first and second lower support bars 102a and 102b and the handrails 110a and 110b, because the portable rehabilitation assembly 100 is devoid of a walkway or platform on which an individual/patient could walk along the ground surface G between the lower support bars 102a and 102b. Thus, the patient is permitted to walk along the ground surface, not a platform, which reduces the likelihood of the patient tripping when ingressing or egressing the walkway. By not having a platform (like prior assemblies), this also reduces the likelihood of an uneven platform due to variations in the ground surface that may cause such platform to be skewed, which can make it difficult for effective pre-gait rehabilitation purposes, particularly if the platform and hand rails are unstable due to the uneven floor surface. Further to this concept and advantage, the portable rehabilitation assembly 100 can accommodate an uneven ground surface because the device 100 has only four ground contact points 116a-d (a four-surface contact point configuration) that can contact the ground surface at different heights along the ground surface. Because the lower support bars are only coupled to each other by the cross-member 104, there may be some slight amount of permissible bending of the first and second lower support bars 102a and 102b relative to each other about the cross member, so that the four ground contact points 116a-d accommodate for an uneven ground surface because each ground contact point can rest on a different plane than other ground contact points. This configuration provides stability for the hand rails when in use because movement of the hand rails will be minimized (as opposed to a more unstable circumstance when supported by a flat platform on the ground that may wiggle on an uneven ground surface when in use). Such stability of the present assembly can be very important when a patient may be placing all of their weight on the hand rails when using the rehabilitation device while re-learning walking, for instance.

The first and second pairs of vertical frame members 108a and 108b can be selectively adjustable (vertically) to set a height of the first and second hand rails 110a and 110b relative to the ground surface G, which can be achieved with a spring/pin combination that locks and unlocks telescoping support members of the vertical frame members 108a and 108b.

A length L1 (FIG. 1D) of the portable rehabilitation assembly 100 can be less than five feet from the front region to the rear region. At least one of the front region 106a or the rear region 106b comprises a walkway opening 140 (FIG. 1A) that leads into the unobstructed walkway W, such that portable rehabilitation assembly 100 is transportable to be adjacent a hospital bed so that a patient can ingress or egress about the walkway opening 140 for pre-gait rehabilitation.

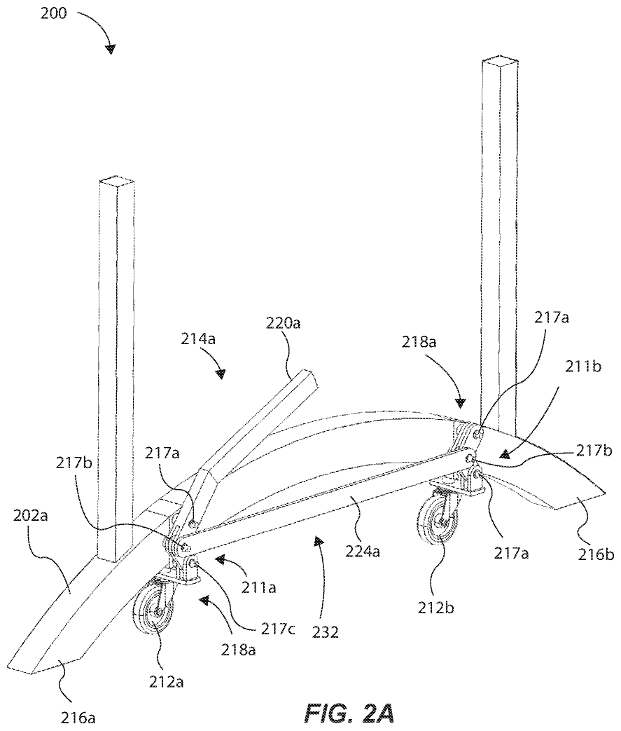

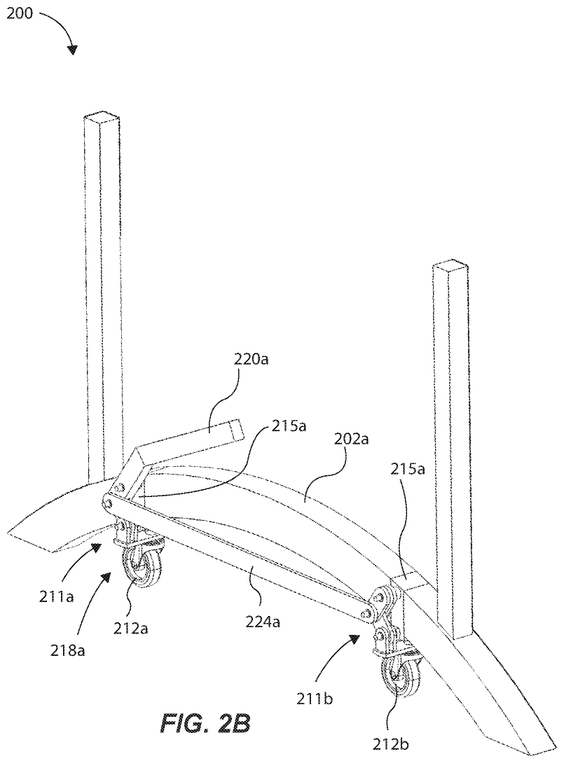

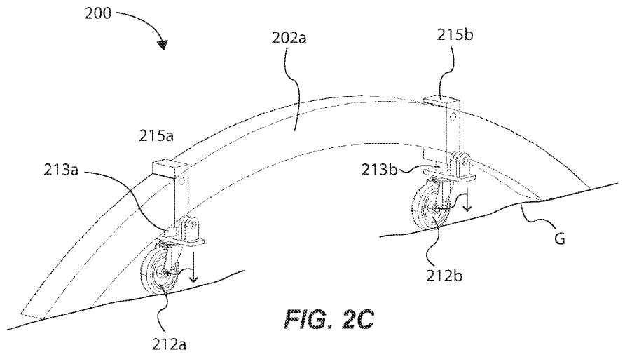

FIGS. 2A-2C illustrate various aspects of a rehabilitation assembly portion 200 of a portable rehabilitation assembly in accordance with one example of the present disclosure. The rehabilitation assembly portion 200 shown in FIG. 2A can be a right-side assembly of a portable rehabilitation assembly having similarly construction and shape as shown in FIG. 1A. As will be appreciated, the assembly portion 200 can be mirrored and duplicated, and coupled together by a cross member (e.g., 104) to form a useable portable rehabilitation assembly. The assembly portion 200 can comprise a lower support bar 202a having a similar arced profile as support bar 102a. A pair of wheels 212a and 212b can be movably coupled to the lower support bar 202a, such that the wheels 212a and 212b are situated underneath the lower support bar 202a and within a void 232 defined by the arced profile of the lower support bar 202a.

The rehabilitation assembly portion 200 can comprise an actuation mechanism 214a operably coupled or linked to the wheels 212a and 212b, and supported by the lower support bar 202a. The actuation mechanisms 214a can be operable to move the portable rehabilitation assembly (including the assembly portion 200) from a stationary rehabilitation position to a portable position by engaging and operating the actuation mechanism 214a (and also by engaging another actuation mechanism of an opposing rehabilitation assembly portion of an assembly like assembly 100). Operating the actuation mechanism 214a engages the pair of wheels 212a and 212b to the ground surface, which lifts ground contact points 216a and 216b of the lower support bar 202a away from the ground surface for transporting the portable rehabilitation assembly in the portable position.

The actuation mechanism 214a can comprise a pivoting linkage actuation mechanism 218a linked to both wheels 212a and 212b for moving the wheels 212a and 212b relative to the lower support bar 202a. The pivoting linkage actuation mechanism 218a can comprise a foot or hand lever 220a that can be pulled in an upward manner (i.e., counterclockwise) to pivot first and second linkage devices 211a and 211b, which are each pivotally coupled to each other on either ends of an actuation rod 224a. Pulling upwardly on the lever 220a causes downward, linear movement of the wheels 212a and 212b relative to the support bar 202a to interface with the ground and lift the support bar 202a. More specifically, the wheels 212a and 212b can translate vertically via telescopic rods 213a and 213b (FIG. 2C) that are slidably disposed through lower openings of respective wheel support portions 215a and 215b of the lower support bar 202a. Such slidable movement of the rods 213a and 213b, which are secured to respective wheels 212a and 212b, upwardly lifts the lower support bar 202a from the ground surface G.

More particularly, the first and second linkage devices 211a and 211b can each be a 3-point or 3-bar linkage having a plurality of links pivotally coupled together by fasteners or pins 217a-c, such that the linkage device 211b, for instance, has a first axis of rotation about upper pin 217a, a second axis of rotation about middle pin 217b, and a third axis of rotation about lower pin 217c. The links are arranged and configured to pivot relative to each other about the pins 217a-c, so that when the lever 220a is pulled and rotated counterclockwise, the actuation rod 224a linearly moves to toward the right, which causes a torque or force to the links to eventually cause translation of the rods 213a and 213b linearly and upwardly into the support portions 215a and 215b. This causes a lifting force to the support portions 215a and 215b of the lower support bar 202a, thereby lifting the lower support bar 202a away from the ground.

The pivoting linkage actuation mechanism 218a is configured to remain in the actuated positon (i.e., the portable position) while a user pushes/rolls the device around the ground surface, and until such time that the user downwardly pushes the lever 220a to re-actuate the pivoting linkage actuation mechanism 218a in the opposite direction, thereby upwardly lifting the wheels 212a and 212b, thereby causing the lower support bar 202a to contact the ground surface to return to the stationary rehabilitation position for use by a patient.

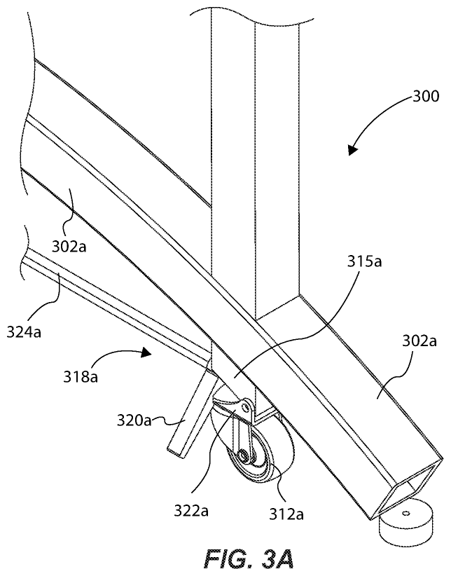

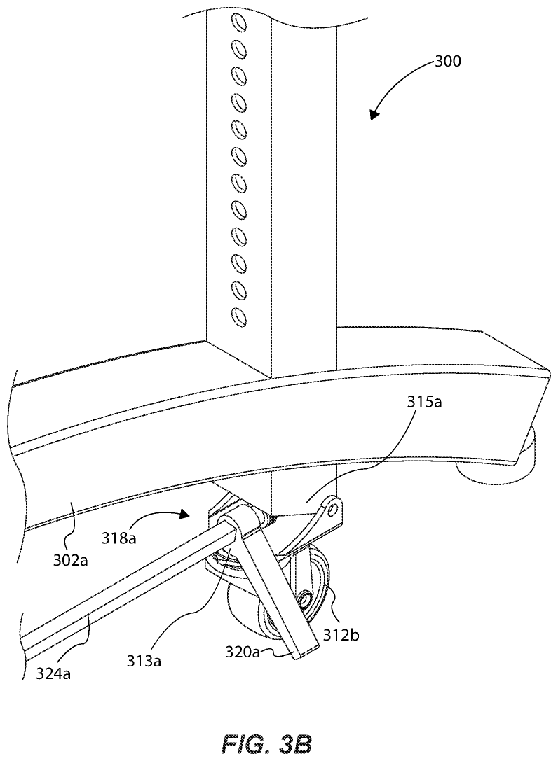

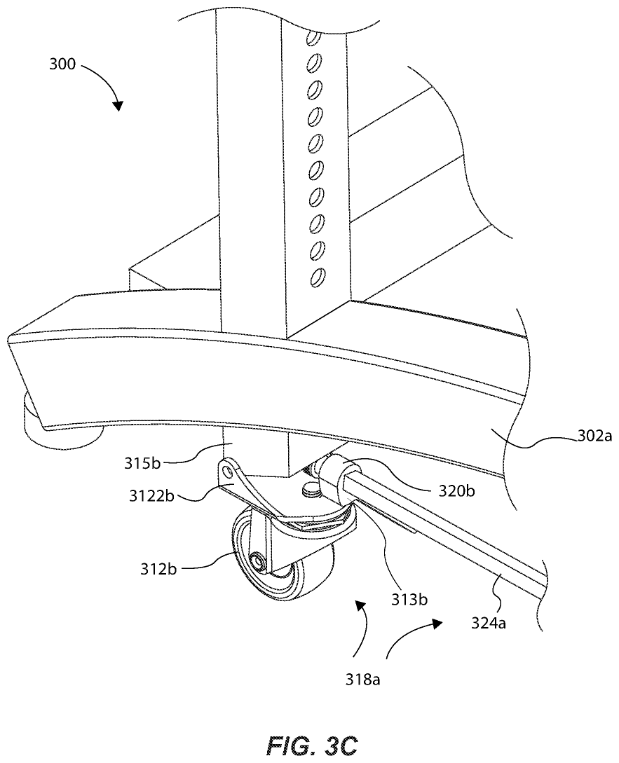

FIGS. 3A-3C illustrate respective front end and rear end sections of a rehabilitation assembly portion 300 in a portable position, in accordance with one example of the present disclosure. The rehabilitation assembly portion 300 can be similarly configured as the portable rehabilitation assembly 100 shown in FIG. 1A (e.g., having cross member, vertical frame members, hand rails, wheels, etc.). One noticeable difference is that a hand or foot lever 320a of a first actuation mechanism 318a (supported by a lower support bar 302a) can be actuated by a user to move between the portable and stationary positions. In this manner, a user can push down or pull up the foot lever 320a to move a portable rehabilitation assembly, including the assembly portion 300, between the stationary rehabilitation positon and the portable position.

More specifically, the first actuation mechanism 318a can have an actuation rod 324a coupling together the foot lever 320a and a cam device 320b supported on either ends of the lower support bar 302a. The foot lever 320a can be oriented orthogonally or transverse relative to the actuation rod 324a, and can have a cam surface 313 that rolls about a planar surface of a bracket 322a supported by the first wheel 312a in response to operating the foot lever 320a. The cam device 320b (FIG. 3C) can have a similar cam surface 313b that rolls about a planar surface of a bracket 322b supported by the wheel 312b when the foot lever 320a is actuated. The brackets 322a and 322b can be pivotally coupled to respective wheel support portions 315a and 315b via pins (not shown) through side apertures of the brackets 322a and 322b. The wheel support portions 315a and 315b can be lower ends of vertical frame supports, or can be separate support structures attached below the lower support bar 302a. Opposing ends of the actuation rod 324a can be biased to a respective lower side surface of each support portion 315a and 315b (FIGS. 3B and 3C). Thus, downward rotation of the foot lever 320a causes its cam surface 313 to roll about the bracket 322a, which causes the actuation rod 324a to translate upwardly which applies a load to the support portion 315a. Concurrently, the actuation rod 324a rotates about its central longitudinal axis to rotate the cam device 320b, which roll about a planar surface of the bracket 322b, which causes the other end of the actuation rod 324a to translate upwardly to apply a load to the support portion 315b. The loads applied to the support portions 315a and 315b via the ends of the actuation rod 324a causes the lower support bar 302a to be lifted off from the ground surface while causing pivoting movement of the brackets 322a and 322b about the lower support bar 302a, which causes the wheels 312a and 312b to interface to the ground to lift the lower support bar 302a from the ground.

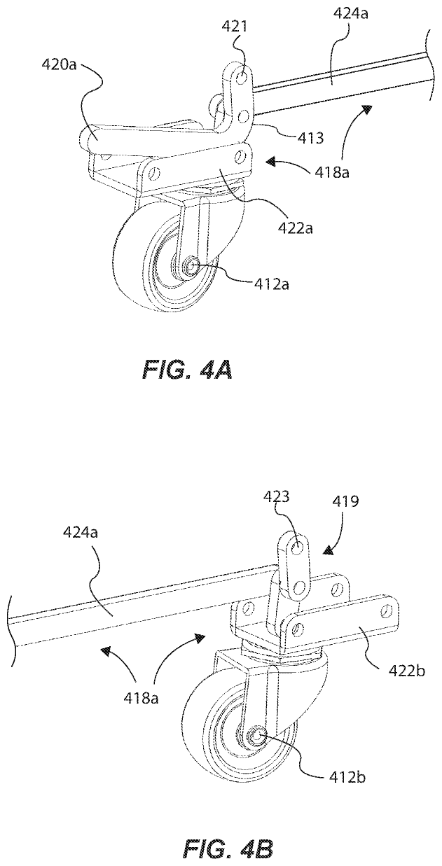

FIGS. 4A and 4B illustrate another example of an actuation mechanism 418a of a portable rehabilitation assembly, and in a portable position, in accordance with one example of the present disclosure. A particular portable rehabilitation assembly having the actuation mechanism 418a can be similarly configured as the portable rehabilitation assembly 100 shown in FIG. 1A (e.g., having a cross member, vertical frame members, hand rails, wheels, etc.). One noticeable difference is that a single foot lever 420a of the actuation mechanism 418a (supported by a lower support bar) can extend linearly and in a direction along a length of the support bar (so that the foot lever 420a does not extend from either side, like the foot lever of FIG. 3A). The foot lever 420a can be pushed down or pulled up to move the portable rehabilitation assembly between the stationary rehabilitation positon and the portable position. Note that FIGS. 4A and 4B show that actuation mechanism 418a in the actuated position, which would interface the wheels 412a and 412b to the ground to be in the portable position.

More specifically, the foot lever 420a can have a cam surface 413 (e.g., curved elbow) that rolls along a planar surface of a bracket 422a supported by a wheel 412a. The bracket 422a can be pivotally coupled to the lower support bar via side apertures of the bracket, similarly as bracket 322a above. The actuation mechanism 418a can further comprise an actuation rod 424a that couples the foot lever 420a to a linkage 419 (FIG. 4B) of the actuation mechanism 418a. The foot lever 420a can be pinned to the lower support bar via aperture 421, and the linkage 419 can be pinned to the lower support bar via aperture 423. Thus, actuation of the foot lever 420a causes a downward pushing force onto the bracket 422a, which causes a lifting force to the lower support bar via the end of the foot lever 420a that is pivotally pinned to the lower support bar. Concurrently, the actuation rod 424a is pulled to the left, which pulls on the linkage 419, which causes a downward force on the bracket 422b, which causing a lifting force to the lower support bar to lift it off the ground while interfacing the wheels 412a and 412b to the ground for transportation.

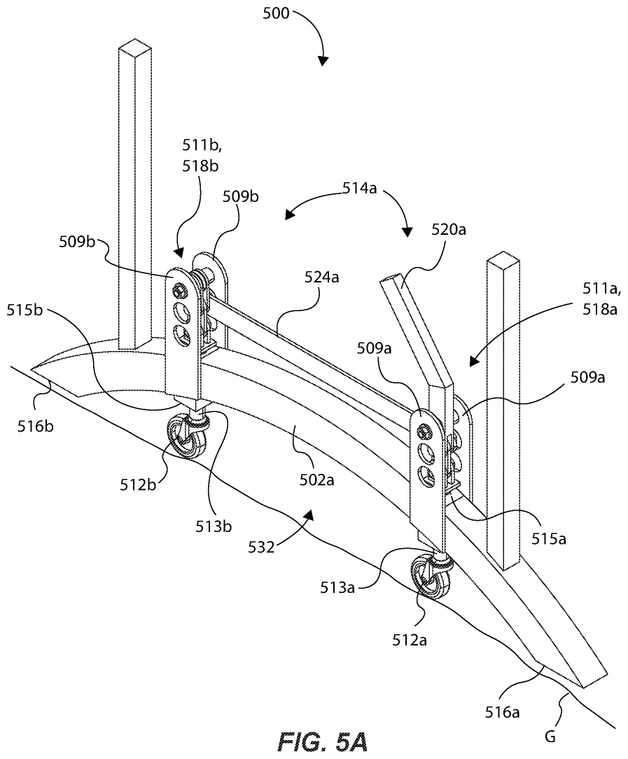

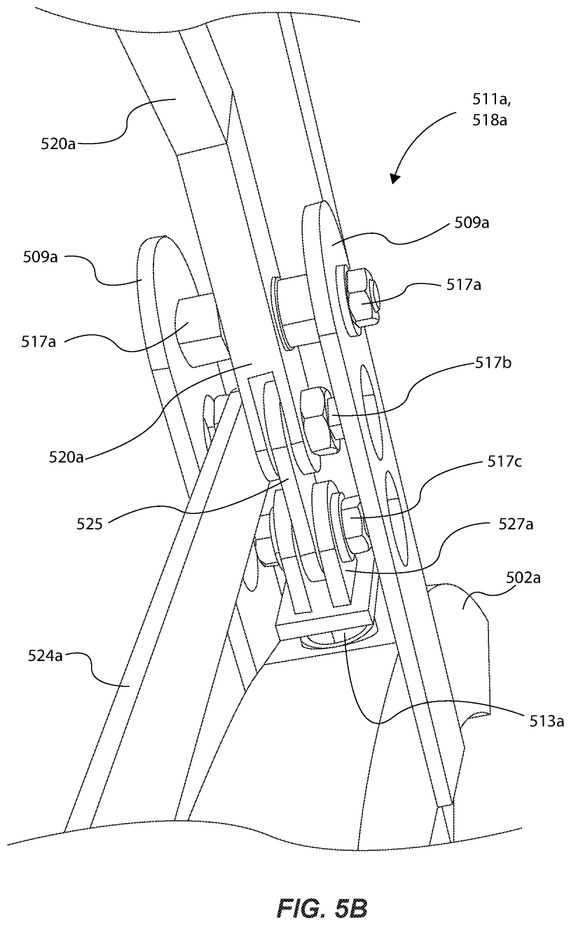

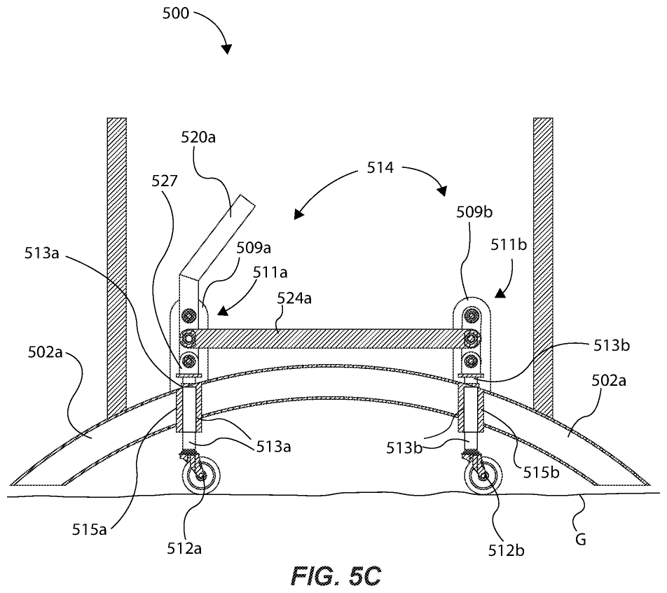

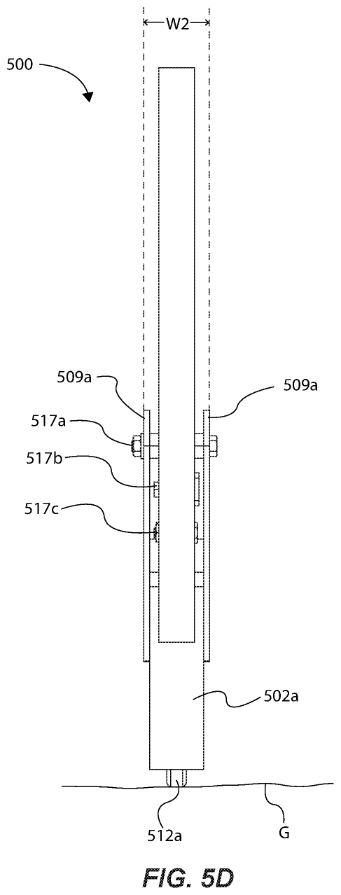

FIGS. 5A-5D illustrate various aspects of a rehabilitation assembly portion 500 in accordance with one example of the present disclosure. The rehabilitation assembly portion 500 shown in FIG. 5A can be a right-side or left-side assembly of a portable rehabilitation assembly having similarly construction and shape as shown in FIG. 1A (e.g., cross bar, vertical frames, hand rails). As will be appreciated, the assembly portion 500 can be mirrored and duplicated, and coupled together by a cross member (e.g., 104) to form a useable portable rehabilitation assembly.

The rehabilitation assembly portion 500 can comprise a lower support bar 502a, and a pair of wheels 512a and 512b movably coupled to the lower support bar 502a. The wheels 512a and 512b can be situated underneath the lower support bar 502a and within a void 532 defined by an arced profile of the lower support bar 502a, similarly as described above. The rehabilitation assembly portion 500 can further comprise an actuation mechanism 514a operably coupled or linked to the wheels 512a and 512b, and supported by the lower support bar 502a. The actuation mechanisms 514a can be operable to move the portable rehabilitation assembly (including one or two of the assembly portions 500) from a stationary rehabilitation position to a portable position by engaging and operating the actuation mechanism 514a. Operating the actuation mechanism 514a engages the pair of wheels 512a and 512b to the ground surface, which lifts ground contact points 516a and 516b of the lower support bar 502a away from the ground surface G for transporting the portable rehabilitation assembly in the portable position (FIGS. 5A, 5C, and 5D).

More particularly, the actuation mechanism 514a can comprise a pivoting linkage actuation mechanism 518a linked to or operably coupled to both wheels 512a and 512b. The pivoting linkage actuation mechanism 518a can comprise a foot or hand lever 520a that can be pulled in an upward manner (the position shown in FIG. 5A) to operate or actuate first and second linkage devices 511a and 511b. The first and second linkage devices 511a and 511b are coupled together on either ends of an actuation rod 524a, so that operating the actuation mechanism 518a causes downward, linear movement of the wheels 512a and 512b relative to the support bar 502a to interface with the ground and lift the support bar 502a. In this manner, the wheels 512a and 512b can translate vertically via telescopic rods 513a and 513b (FIGS. 5A and 5C) that are slidably disposed through lower openings of wheel support portions 515a and 515b of the lower support bar 502a. Such slidable movement of the rods 513a and 513b (secured to the wheels) upwardly lifts the lower support bar 502a from the ground surface G.

More specifically regarding operation of the actuation mechanism 518a, opposing pairs of linkage support plates 509a and 509b can be attached to or supported by the lower support bar 502a, such that each plate of each pair of linkage support plates 509a and 509b are spatially separated and parallel to each other. The first and second linkage devices 511a and 511b can be supported by the respective pairs of linkage support plates 509a and 509b. Each linkage device 511a and 511b can be a 3-bar or 3-point linkage system having a plurality of links or support members pivotally coupled together by fastener assemblies 517a-c (FIG. 5B). Note that the fastener assemblies 517a-c can each be an assembly of spacer(s), washer(s), bolt(s), and/or nut(s) arranged and configured to facilitate pivotal rotation of adjacent links coupled together by the particular fastener assembly.

In this configuration, the lever 520a can be pivotally coupled to upper ends of the pair of linkage support plates 509a via fastener assembly 517a through an upper aperture of the lever 520a, and further pivotally coupled to the actuation rod 524a and to an intermediate linkage 525 via fastener assembly 517b that extends through apertures of the rod 524a, the intermediate linkage 525, and the lever 520a. The other end of the intermediate linkage 525 can be pivotally coupled to a wheel support body 527 by fastener assembly 517c. The wheel support body 527 comprises or supports the telescopic rod 513a that extends through the lower support bar 502a and that is coupled to or supported by the wheel 512a. Note that, the second linkage device 511b (supported by linkage support plates 509b) can operate and be configured in a similar manner as the first linkage device 511a, except that the second linkage device 511b does not require a lever, because the actuation rod 524a applies the force required to operate the second linkage device 511b. Accordingly, when the lever 520a is pushed downwardly from the position shown in FIGS. 5A-5C, the actuation rod 524a is caused linearly move toward the right (FIG. 5A) due to the pivoting movement of the intermediate linkage 525 and the fastener assembly 517b pivoting and moving relative to fastener assembly 517a (which is fixed to the support plates 509a). This movement of the intermediate linkage 525 causes an upward pulling force on the wheel support body 527, which causes the telescopic rod 513a to linearly move upwardly, which draws or lifts upwardly the wheel 512a relative to the lower support bar 502a to interface the lower support bar 502a to the ground. Concurrently, a similar movement of the second linkage device 511b is effectuated via a pulling force or load translated from the actuation rod 524a to the second linkage device in a direction toward the first linkage device 511a, which (similarly) causes the wheel 512b to move upwardly relative to the lower support bar 502a while the other wheel 512a moves. As expected, pulling upward on the lever 520a to the position shown in FIGS. 5A-5D causes the opposite or inverse effect of engaging the wheels 512a and 512b to the ground surface G to lift the lower support bar 502a from the ground surface G to be in the portable transport position shown.

Notably, the actuation mechanism 514a is almost entirely, or entirely, situated within a lateral distance or width W2 of the assembly portion 500, as shown in FIG. 5D. That is, the lever 520a and the linkage devices 511a and 511b do not extend outwardly from either side of parallel, vertical planes defined by the lower support bar 502a. This contributes to the compact nature of the assembly portion 500, and also helps to keep clear an unobstructed walkway (e.g., see walkway W of FIG. 1A) from components that might extend inwardly into the walkway, so that a patient can ingress or egress without obstruction. Moreover, because the actuation mechanism 514a is centered relative to, or positioned directly above, the lower support bar 502a, loads are more evenly distributed when moved and operated in the portable position, which reduces stresses on components of the assembly. That is, the lifting force or loads exerted onto the wheels 512a and 512b from pulling up on the lever 520a are acting generally vertically downward on the wheels 512a and 512b through the telescopic rods 513a and 513b. This causes a symmetrical lifting force on the assembly portion 500 via the wheels 512a and 512b interfacing to the ground surface G. Reducing stresses and distributing loads in this manner contributes to the portability and light-weight features of the assembly.

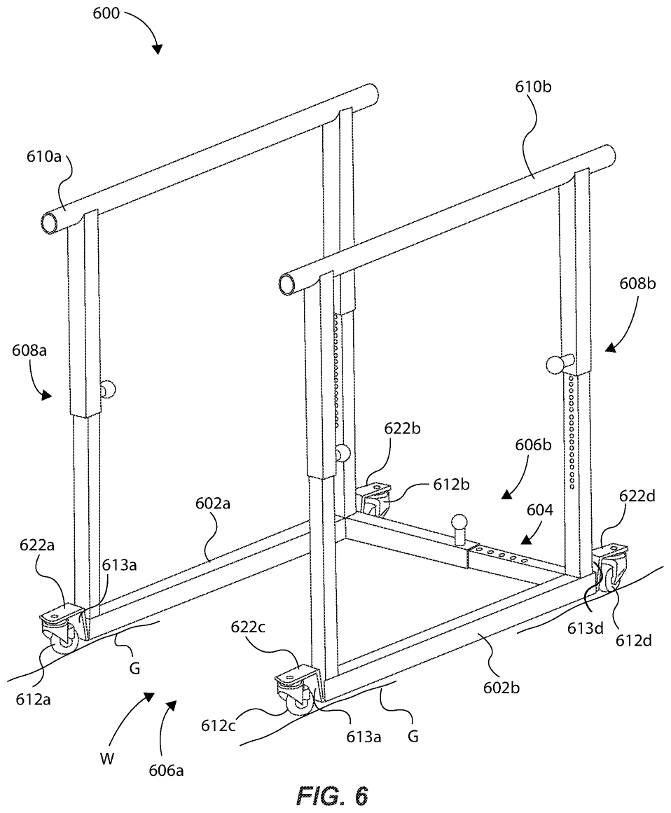

FIG. 6 illustrates a portable rehabilitation assembly 600 in accordance with one example of the present disclosure. The portable rehabilitation assembly 600 can comprise first and second lower support bars 602a and 602b coupled together by a cross bar 604, and that support respective first and second pairs of vertical frames 608a and 608b, and which support hand rails 610a and 610b to form an unobstructed walkway W from a front region 606a to a rear or back region 606b. One noticeable difference is that the first and second lower support bars 602a and 602b are each generally flat or linear square bars that support respective wheels 612a-d. The wheels 612a-d are each situated outwardly from end portions of respective first and second lower support bars 602a and 602b. In this manner, compliant members or brackets 622a-d are secured to respective ends of respective first and second support bars 602a and 602b. Each compliant bracket 622a-d can be secured to an underneath side of the respective support bar 602a and 602b, and then can extend upwardly at an angle to define an angled flexed portion 613a-d, respectively, and then extend horizontally above the respective wheel 612a-d for coupling to the wheel. Each compliant bracket 622a-d can be a thin sheet or panel of steel (or other semi-rigid or rigid material) that, when combined together, are rigid enough to resist and support the weight of the assembly 600 when not in use. That is, the assembly 600 defaults to the portable position (when not in use) because the brackets 622a-d cooperate bias the wheels 612a-d against the ground, which causes a lifting force to slightly lift the support bars 602a and 602b off the ground surface. Accordingly, in response to a load or weight being pushed down onto the support bars 602a and 602b via the hand rails 610a and 610b from a patient, the compliant brackets 622a-d flex or bend until the lower support bars 602a and 602b interface to the ground surface, so that the patient can use the assembly 600. In one example, the brackets 622a-d can be actuated by horizontal motion through the lower support bars 602a and 602b, which would be translated by the brackets 622a-d into a vertical motion.

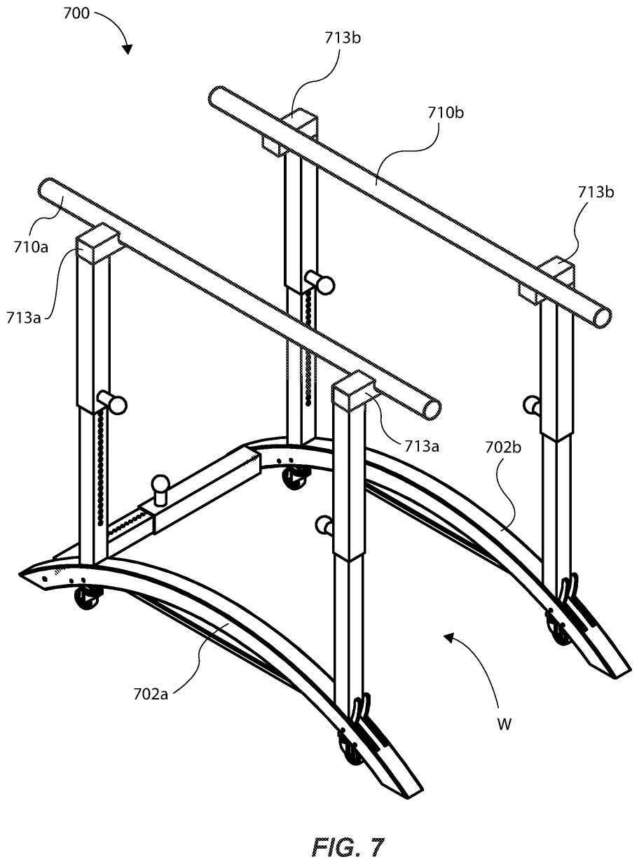

FIG. 7 shows a portable rehabilitation assembly 700 in accordance with one example of the present disclosure. The portable rehabilitation assembly 700 can be similarly configured as the portable rehabilitation assembly 100 shown in FIG. 1A (e.g., having a cross member, vertical frame members, hand rails, wheels, etc.). In one example, the assembly 700 may be fabricated without wheels.

One noticeable difference in this example is that first and second hand rails 710a and 710b can be inwardly offset relative to respective first and second lower support bars 702a and 702b. More specifically, pairs of off-set support bars 713a and 713b can be attached to respective vertical frames 708a and 708b, and can support the hand rails 710a and 710b to position them inwardly toward each other and into an area defined by an unobstructed walkway W. This configuration can allow for some amount of clearance for the patient to walk along the assembly 700 without contacting the lower support bars 702a and 702b with his or her feet, which may be a safety concern.

The vertical frame members of the examples discussed herein can be selectively adjustable with a motor, such an electric motor coupled to each pair of vertical frame members (being telescopic supports). In a simplified version, the vertical frame members can be vertically adjustable using manual adjustment mechanisms, such as detents or movable pins (e.g., FIG. 1A), which secure a telescoping portion to a base portion of each vertical frame member. The manual adjustment mechanism can be threaded bolts that compress/secure the telescoping portion when tightened by an individual, and release the telescoping portion when loosened. Alternatively, the manual adjustment mechanism can be a pin/spring configuration that is actuated by an individual when adjusting the height of a telescoping member.

In one example, the first and second hand rails each comprise a telescoping hand rail (not shown) to vary a length of each hand rail. In this way, the hand rails can extend a couple feet or more (for example) beyond the end of the front region. This can provide extended support for a patient to grasp the hand rails before walking into the area between the lower support bars, which can be useful when the assembly is positioned toward a hospital bed that vertically positions a patient near a standing position.

Although dimensions can vary for the various examples discussed herein, generally a length of the walkway defined from a front region to a back region of the lower support bars can range from about 3 feet to 5.5 feet, and often from about 4 feet to about 5 feet. In one example, the length of the walkway is less than 5 feet from the front region to the rear region. Existing rehabilitation parallel bar devices are at least 7 feet. A total length of less than 5 feet contributes to the “compact” nature of the portable rehabilitation assembly because the portable rehabilitation assembly is shorter than existing rehabilitation parallel bar devices. Similarly, the walkway can have a width (between first and second lower support bars) from about 2.2 feet to 4 feet, in some case from about 2.7 feet to 3.5 feet, and often about 3 feet. This compact configuration allows an individual to turn around corners and enter doorways when transporting the device around a hospital, for example.

In one example, the unobstructed walkway is approximately 4 feet long and 3 feet wide. A width between adjacent vertical frame members can be approximately 30 inches (or it can vary in width), but generally can vary from about 24 to 40 inches. The vertical frame members can generally result in a hand rail height from the ground surface from about 2.5 feet to about 4 feet, although the height can be adjustable for varying patients. The casters can be rubber wheels approximately 3 inches (or more) in diameter. The entire assembly can weigh approximately 75 pounds or less.

In yet another alternative, the wheels can be operated by a single lever that translates lever motion to all four wheels through a telescoping linkage within the cross member and horizontal linkages previously described.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A portable rehabilitation assembly for pre-gait rehabilitation, comprising:
first and second lower support bars positioned substantially parallel to each other;
a cross-member coupling the first and second lower support bars to each other proximate back ends of the first and second lower support bars, and wherein front ends of the first and second lower support bars form a front region;
a first pair of vertical frame members coupled to the first lower support bar, and a second pair of vertical frame members coupled to the second lower support bar;
a first hand rail coupled to the first pair of vertical frame members, and a second hand rail coupled to the second pair of vertical frame members and positioned substantially parallel to the first hand rail, such that the first and second hand rails and the front region form an unobstructed walkway from the front region to a back region of the portable rehabilitation assembly; and
a first pair of wheels coupled to the first lower support bar, and a second pair of wheels coupled to the second lower support bar, wherein the first and second pairs of wheels are situated within a lateral distance defined by a width between the first and second lower support bars.

2. The portable rehabilitation assembly of claim 1, further comprising at least one actuation mechanism operably coupled to at least one of the first or second pairs of wheels, the at least one actuation mechanism operable to move the portable rehabilitation assembly from a stationary rehabilitation position to a portable position by engaging the at least one actuation mechanism to cause the first and second pairs of wheels to a ground surface, thereby lifting the first and second lower support bars from the ground surface for transporting the portable rehabilitation assembly in the portable position.

3. The portable rehabilitation assembly of claim 2, wherein the at least one actuation mechanism comprises a first cam device operably coupled to the first pair of wheels and supported by the first lower support bar, and a second cam device operably coupled to the second pair of wheels and supported by the second lower support bar, and an actuation rod coupling together the first and second cam devices.

4. The portable rehabilitation assembly of claim 1, wherein the cross-member comprises first and second tubes telescopically coupled together and operable to adjust a distance between the first and second lower support bars, and a distance between the first and second hand rails.

5. The portable rehabilitation assembly of claim 4, wherein the first tube is secured to the first lower support bar, and the second tube is secured to the second lower support bar, wherein the first and second tubes comprise a plurality of locking positions to vary a distance between the first and second lower support bars.

6. The portable rehabilitation assembly of claim 1, wherein outer side surfaces of each of the first and second lower support bars define a lateral profile of the portable rehabilitation assembly, and wherein the first and second pairs of wheels are situated within the lateral profile.

7. The portable rehabilitation assembly of claim 1, wherein the unobstructed walkway comprises a generally rectangular cuboid region.

8. The portable rehabilitation assembly of claim 1, wherein the unobstructed walkway is further defined by a ground surface that supports the portable rehabilitation assembly, such that the portable rehabilitation assembly is devoid of a platform on which an individual walks.

9. The portable rehabilitation assembly of claim 1, wherein, when in a stationary rehabilitation position, ground contact points of the first and second lower support bars contact a ground surface.

10. The portable rehabilitation assembly of claim 1, wherein the first and second lower support bars each comprise an arced profile that extends from the back region to the front region, wherein each arced profile defines a void underneath the respective first and second lower support bars, and wherein the first and second pairs of wheels are at least partially situated in the respective void of the respective first and second lower support bars.

11. The portable rehabilitation assembly of claim 10, wherein each arced profile define a lower perimeter boundary of the portable rehabilitation assembly.

12. The portable rehabilitation assembly of claim 1, wherein the first and second lower support bars each comprise an upper convex portion that at least partially supports respective first and second pairs of vertical frames, and wherein the first and second lower support bars each comprise a lower concave portion that at least partially supports respective first and second pairs of wheels.

13. The portable rehabilitation assembly of claim 12, further comprising a first actuation mechanism operably coupled to the first pair of wheels and supported by the first lower support bar, and a second actuation mechanism operably coupled to the second pair of wheels and supported by the second lower support bar, wherein the first and second actuation mechanisms are operable to move the portable rehabilitation assembly from a stationary rehabilitation position to a portable position for transporting via the first and second pairs of wheels.

14. The portable rehabilitation assembly of claim 13, wherein the first and second actuation mechanisms each comprise a lever operable to move the portable rehabilitation assembly from the stationary rehabilitation position to the portable position by causing the first and second pairs of wheels to engage a ground surface to lift the first and second lower supports away from the ground surface for transporting the portable rehabilitation assembly in the portable position.

15. The portable rehabilitation assembly of claim 1, wherein the first and second pairs of vertical frames are selectively adjustable a height of the first and second hand rails relative to the ground surface.

16. The portable rehabilitation assembly of claim 1, wherein a length of the portable rehabilitation assembly is less than five feet from the front region to the back region.

17. The portable rehabilitation assembly of claim 1, wherein the front region comprises a walkway opening, such that portable rehabilitation assembly is transportable adjacent a hospital bed such that a patient can ingress or egress about the walkway opening for pre-gait rehabilitation.

18. The portable rehabilitation assembly of claim 1, wherein the first and second pairs of wheels do not extend outwardly beyond a lower perimeter boundary defined by the first and second lower support bars.

19. The portable rehabilitation assembly of claim 1, wherein the first and second lower support bars each comprise a pair of ground contacting surfaces that defines a four-surface contact point configuration when the portable rehabilitation assembly is in a stationary rehabilitation position to account for height variations in a ground surface supporting the portable rehabilitation assembly.

20. The portable rehabilitation assembly of claim 1, further comprising a first actuation mechanism supported by the first lower support bar, and a second actuation mechanism supported by the second lower support bar, wherein the first actuation mechanism comprises a lever, a first linkage coupled to the one wheel, a second linkage coupled to another wheel, and an actuation bar coupled between the first and second linkages, such that rotation of the lever causes the first lower support bar to translate vertically relative to the first pair of wheels, thereby lifting the first lower support bar away from the ground surface for transport of the portable rehabilitation assembly.

21. The portable rehabilitation assembly of claim 20, further comprising a second actuation mechanism supported by the second lower support bar, wherein the second actuation mechanism is substantially similar to the first actuation mechanism.

22. The portable rehabilitation assembly of claim 20, wherein the lever is laterally situated within a width of the first lower support bar.

23. A portable rehabilitation assembly for pre-gait rehabilitation, comprising:
first and second support bars positioned substantially parallel to each other and configured to contact a ground surface;
an adjustable cross-member coupling together the first and second arced supports proximate back ends of the first and second support bars, and wherein front ends of the first and second support bars form a front region, the adjustable cross-member operable to adjust the width of the portable rehabilitation assembly;
a first pair of vertical frames coupled to the first support bar, and a second pair of vertical frame members coupled to the second support bar; and
a first hand rail coupled to the first pair of vertical frames, and a second hand rail coupled to the second pair of vertical frames and positioned substantially parallel to the first hand rail to form an unobstructed walkway from a back region, proximate the back ends, to the front region.
